(19) United States
(12) Patent Application Publication
(10) Pub. No.: US 2008/0111466 A1
(43) Pub. Date: May 15, 2008

(54) ELECTRON EMISSION MATERIAL AND ELECTRON EMISSION DISPLAY DEVICE HAVING THE SAME

(76) Inventors: Young-Mi Cho, Suwon-si (KR); Chang-Wook Kim, Suwon-si (KR); Ji-Soon Ihm, Suwon-si (KR)

Correspondence Address: CHRISTIE, PARKER & HALE, LLP, PO BOX 7068, PASADENA, CA, 91109-7068, US

(21) Appl. No.: 11/876,599

(22) Filed: Oct. 22, 2007

(30) Foreign Application Priority Data
Nov. 10, 2006 (KR) 10-2006-0111244

(51) Int. Cl. H01J 1/62

(52) U.S. Cl. 313/495

(57) ABSTRACT

An electron emission material having high electron emission efficiency and long lifespan, and an electron emission device and an electron emission display device having the electron emission material. The electron emission material has a surface to which hydrogen atoms are attached. The electron emission display device includes: a front panel having a phosphor layer; an electron emission device adhered to the front panel with a space therebetween; and a hydrogen emitter in the space defined by the front panel and the electron emission device.

### CROSS-REFERENCE TO RELATED PATENT APPLICATION

This application claims priority to and the benefit of Korean Patent Application No. 10-2006-0111244, filed on Nov. 10, 2006, in the Korean Intellectual Property Office, the entire content of which is incorporated herein by reference.

### BACKGROUND OF THE INVENTION

1. Field of the Invention

The present invention relates to an electron emission material and an electron emission display device having the same.

2. Description of the Related Art

Electron emission display devices are flat panel displays that generate visible light due to the excitation of phosphor layers with electrons emitted by electron emission devices. There are various types of electron emission devices for electron emission display devices. For example, there are field emitter type electron emission devices (or field emitters) that emit electrons using an electron tunneling event and a peak-discharging effect on the end of a micro tip. In order to prevent (or reduce) a decrease in lifespan and electron emission efficiency due to degradation of the micro tip, the field emitters may include carbon nanotubes as an electron emission material.

In this case, however, Joule heat generated by the electrical resistance of the carbon nanotubes or adsorption of an active gas during operation results in a change of an electronic and atomic structure, thereby degrading the electron emission performance of the carbon nanotubes. Therefore, there is a need to solve this problem.

### SUMMARY OF THE INVENTION

Aspects according to embodiments of the present invention are directed to an electron emission material having low electrical resistance, high electron emission efficiency, high operation stability, and/or long lifespan, and/or an electron emission display device having the electron emission material.

Aspects of embodiments of the present invention provide an electron emission material having high electron emission efficiency and/or long lifespan, and/or an electron emission display device having the same.

According to an embodiment of the present invention, there is provided an electron emission material having a surface to which hydrogen atoms are attached.

According to another embodiment of the present invention, there is provided an electron emission display device including: a front panel having a phosphor layer; an electron emission device adhered to the front panel with a space therebetween; and a hydrogen emitter in the space defined by the front panel and the electron emission device.

In one embodiment, the hydrogen emitter includes a hydrogen compound including at least one metallic element selected from the group of consisting of Zr, Ti, Ta, V, Mg, Th, Mn, Fe, Co, and Ni.

In one embodiment, the front panel includes: a front substrate including a visible light transmitting material; an anode on a side of the front substrate facing the electron emission device; and a phosphor layer adjacent to the anode. The hydrogen emitter may be disposed on the front panel.

In one embodiment, the electron emission device includes: a base substrate; a plurality of cathodes on a side of the base substrate facing the front panel; a plurality of insulating layers disposed on the cathodes and having a plurality of first electron emission source holes to partially expose the cathodes; a plurality of gate electrodes on the insulating layers and having a plurality of second electron emission source holes to partially expose the cathodes; and a plurality of electron emission sources electrically connected to the cathodes in the first and second electron emission source holes.

In one embodiment, the electron emission device includes: a base substrate; a plurality of cathodes on a side of the base substrate facing the front panel; a plurality of first insulating layers on the cathodes and having a plurality of first electron emission source holes to partially expose the cathodes; a plurality of gate electrodes on the first insulating layers and having a plurality of second electron emission source holes to partially expose the cathodes; a plurality of second insulating layers on the gate electrodes and having a plurality of third electron emission source holes to partially expose the cathodes; a plurality of focusing electrodes on the second insulating layers and having a plurality of fourth electron emission source holes to partially expose the cathodes; and a plurality of electron emission sources electrically connected to the cathodes in the first, second, third, and fourth electron emission source holes.

In one embodiment, the electron emission device includes: a base substrate; a plurality of first electrodes formed on a side of the base substrate facing the front panel; a plurality of second electrodes facing the first electrodes; and a plurality of electron emission sources disposed between the first electrodes and the second electrodes, each of the electron emission sources having a nanogap on a conductive portion between one of the first electrodes and a corresponding one of the second electrodes.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a cross-sectional schematic view of an electron emission display device according to an embodiment of the present invention;

FIG. 2 is an enlarged cross-sectional schematic view of portion 11 of FIG. 1, illustrating an electron emission device having an electron emission material according to an embodiment of the present invention;

FIG. 3 is a partial cross-sectional schematic view of an electron emission device having an electron emission material according to another embodiment of the present invention;

FIG. 4 is a schematic view illustrating an operation of a metal catalyst for hydrogen dissociation; and

FIG. 5 is a partial cross-sectional schematic view illustrating another electron emission device.

### DETAILED DESCRIPTION

In the following detailed description, only certain exemplary embodiments of the present invention are shown and described, simply by way of illustration. As those skilled in the art would realize, the described exemplary embodiments may be modified in various different ways, all without departing from the spirit or scope of the present invention. Accordingly, the drawings and description are to be regarded as illustrative in nature, and not restrictive.

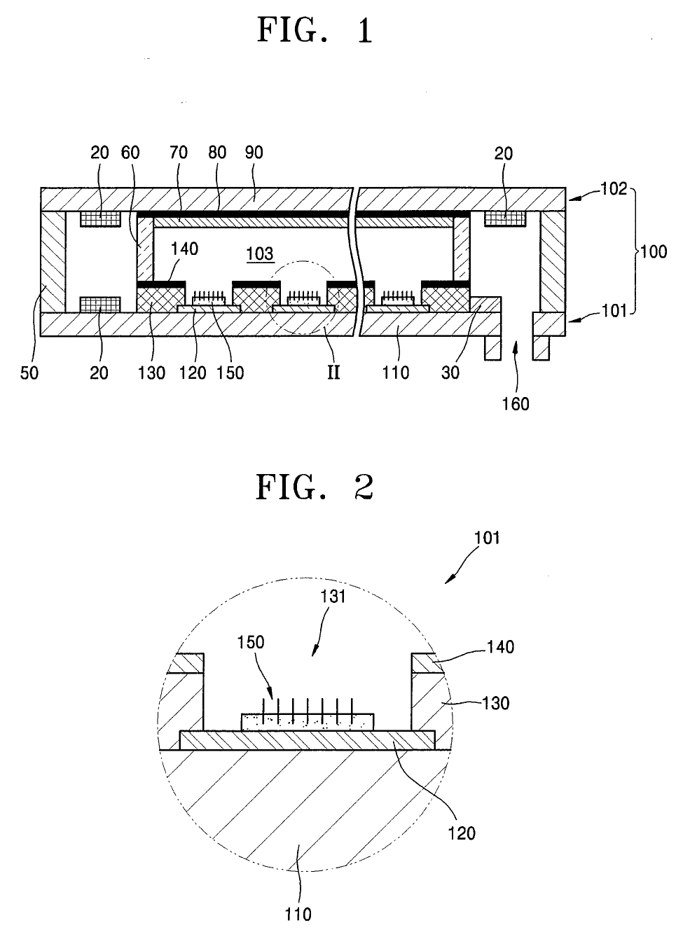

FIG. 1 is a cross-sectional schematic view of an electron emission display device 100 according to an embodiment of the present invention. FIG. 2 is an enlarged cross-sectional schematic view of portion 11 of FIG. 1.

Referring to FIG. 1, the electron emission display device 100 includes a front panel 102, and an electron emission device 101 adhered by a sealing material 50 to the front panel 102 to form a vacuum space 103 (that may be predetermined).

The front panel 102 includes a front substrate 90, an anode 80, and a phosphor layer 70. The front substrate 90 is made of a material through which visible light is transmitted, and the anode 80 and the phosphor layer 70 are disposed on a rear surface of the front substrate 90.

The anode 80 may be made of any suitable material having electrical conductivity. The anode 80 accelerates electrons emitted by an electron emission structure formed on a base substrate 110 and excites the phosphor layer 70. For example, the anode 80 may be made of Al, Ti, Cr, Ni, Au, Ag, Mo, W, Pt, Cu, Pd, and/or alloys thereof; a printed conductor including glass and at least one material selected from the group consisting of Pd, Ag, RuO₂ and Pd—Ag; a transparent conductor such as ITO, In₂O₃, and/or SnO₂; and/or a semiconductor material such as polysilicon.

The phosphor layer 70 is made of a cathode luminescent (CL) phosphor that is excited by the electrons accelerated by the anode 80 to emit visible light. Examples of the phosphor used for the phosphor layer 70 include, but are not limited to, a red light emitting phosphor such as SrTiO₃:Pr, Y₂O₃:Eu, and/or Y₂O₃S:Eu, a green light emitting phosphor such as Zn(Ga, Al)₂O₄:Mn, Y₃(Al, Ga)₅O₁₂:Tb, Y₂SiO₅:Tb, and/or ZnS:Cu,Al, and a blue light emitting phosphor such as Y₂SiO₅:Ce, ZnGa₂O₄, and/or ZnS:Ag,Cl.

The electron emission device 101 may be of various suitable types. That is, the electron emission device 101 may include a hot cathode as an electron emission source, or a cold cathode as an electron emission source. In particular, examples of the electron emission device 101, which includes a cold cathode, are a field emission device (FED), a surface conduction emitter (SCE), a metal insulator metal (MIM) emitter, a metal insulator semiconductor (MIS) emitter, and a ballistic electron surface emitter (BSE).

The FED includes a material having a low work function and/or a high beta function as an electron emission source such that electrons can be easily emitted due to an electric field difference in a vacuum. A tip structure mainly made of Mo or Si, or a structure made of a carbon-based material such as graphite or diamond like carbon (DLC), or a nanomaterial such as nanotube or nanowire has been developed for use as the electron emission source for the FED.

The SCE is configured such that a conductive thin film is provided between facing first and second electrodes on a base substrate and a nanogap is formed on the conductive thin film. The SCE operates on the principle that, when a voltage is applied to the first and second electrodes to let current flow over the conductive thin film, electrons are emitted from the nanogap due to an electron tunneling phenomenon.

The MIM and the MIS emitters respectively have an MIM structure and an MIS structure such that, when a voltage is applied between two metals or between a metal and a semiconductor which have an insulator therebetween, electrons migrate from the metal or semiconductor having a higher electrochemical potential to the metal having a lower electrochemical potential, and are accelerated during the migration to be emitted outwardly.

The BSE is based on the principle that, when the size of a semiconductor is reduced to a range smaller than an average free stroke of electrons, the electrons can be moved without being scattered. The BSE includes an electron supply layer made of a metal or a semiconductor formed on an ohmic electrode and an insulating layer and a metal thin film formed on the electron supply layer, and emits electrons by power applied to the ohmic electrode and the metal thin film.

FIG. 2 is an enlarged cross-sectional schematic view of portion 11 of FIG. 1, illustrating the electron emission device 101. In the present embodiment, the electron emission device 101 is a FED type electron emission device. Referring to FIG. 2, the electron emission device 101 may include the base substrate 110, a plurality of cathodes 120, a plurality of gate electrodes 140, a plurality of first insulating layers 130, and a plurality of electron emission sources 150.

The base substrate 110 is a plate, such as a quartz glass, a glass with small impurities such as Na, a plate glass, a glass substrate coated with SiO₂, an aluminium oxide substrate, or a ceramic substrate, having a thickness that may be predetermined. For a flexible display apparatus, the base substrate 110 may be made of a flexible material.

Each of the cathodes 120 extends in a first direction on the base substrate 110, and the cathodes 120 and the first insulating layers 130 are disposed between the gate electrodes 140 and the base substrate 110. The cathodes 120 and the gate electrodes 140 may be made of the same (or substantially the same) conductive material as the anodes 80.

In more detail, the first insulating layer 130 is disposed between the cathode 120 and the gate electrode 140 to insulate the cathode from the gate electrode 140 and prevent (or reduce) a short circuit between the two electrodes.

The electron emission sources 150 are electrically connected to the cathodes 120. The electron emission sources 150 may include a carbon material and/or a nanomaterial as an electron emission material. An uppermost portion of the electron emission source 150 may be lower in height than that of the gate electrode 140 (or lower in height than that of the lowermost portion of the gate electrode 140).

Examples of the carbon material used as the electron emission material for the electron emission source 150 include carbon nanotube, graphite, diamond, and diamond like carbon, which have a low work function and a high beta function. Examples of the nanomaterial used as the electron emission material for the electron emission source 150 include nanotubes, nanowires, and nanorods. In particular, since carbon nanotubes have excellent electron emission characteristic and operate at a low voltage, the electron emission device 101 having the carbon nanotubes can be made to be relatively large.

Spacers 60 are disposed between the front panel 102 and the electron emission device 101 to space the front panel 102 apart from the electron emission device 101. The spacers 60 are installed discretely (or unconnectedly to each other) in a direction perpendicular to the plane of the FIG. 1, and the vacuum space 103 is not sealed by the spacers 60. The spacers 60 may be made of an insulating material.

An exhaust outlet 160 is formed on a side of the vacuum space 103 formed by the front panel 102 and the electron emission device 101 to exhaust a residual gas. At least one hydrogen emitter 20 is installed at a position (that may be predetermined) on an inner wall of the vacuum space 103.

Because the front panel 102 has a more simple structure and is made through fewer processes than the electron emission device 101, the hydrogen emitter 20 is installed on the inner wall of the front panel 102 according to one embodiment of the present invention. The hydrogen emitter 20 is made of a hydrogen compound containing at least one metallic element selected from the group of metallic elements including Zr, Ti, Ta, V, Mg, Th, Mn, Fe, Co, and Ni.

The exhaust outlet may be sealed by a plug. The exhaust outlet 160 can be formed on the electron emission device 101 as illustrated in FIG. 1, but the location of the exhaust outlet is not limited to the electron emission device 101 as illustrate in FIG. 1.

Also, a getter material 30 may be deposited to remove a gas in the vacuum space 103. The getter material 30, which is used to remove gas molecules remaining in a vacuum container even after an exhausting process, may be an evaporable getter material, such as barium (Ba), and/or may be a non-evaporable getter material in which a surface of the material is activated to adsorb a residual gas. The getter material 30 is deposited on the inside of the electron emission display device 100, particularly, on the inside of an exhaust pipe, and evaporates by heating or is activated on its surface to adsorb a residual gas after the exhausting and sealing processes of the electron emission display device 100.

In order to not only generate visible light so as to function as a light source or a lamp, but also to create an image, the electron emission display device 100 may be configured such that the cathode 120 and the gate electrode 140 of the electron emission device 101 cross each other. In this case, a pixel in which visible light is to be generated can be easily selected.

The electron emission display device 100 constructed as described above operates as follows.

A negative (−) voltage is applied to the cathode 120 and a positive (+) voltage is applied to the gate electrode 140 to emit electrons from the electron emission source 150 installed on the cathode 120. Also, a strong positive (+) voltage is applied to the anode 80 to accelerate electrons heading for the anode 80. That is, the electrons emitted from the electron emission material of the electron emission source 150 are directed toward the gate electrode 140 and then are accelerated by the anode 80. The electrons accelerated by the anode 80 collide with the phosphor layer 70 disposed on the anode 80 to excite the phosphor layer 70, which thereby generates visible light.

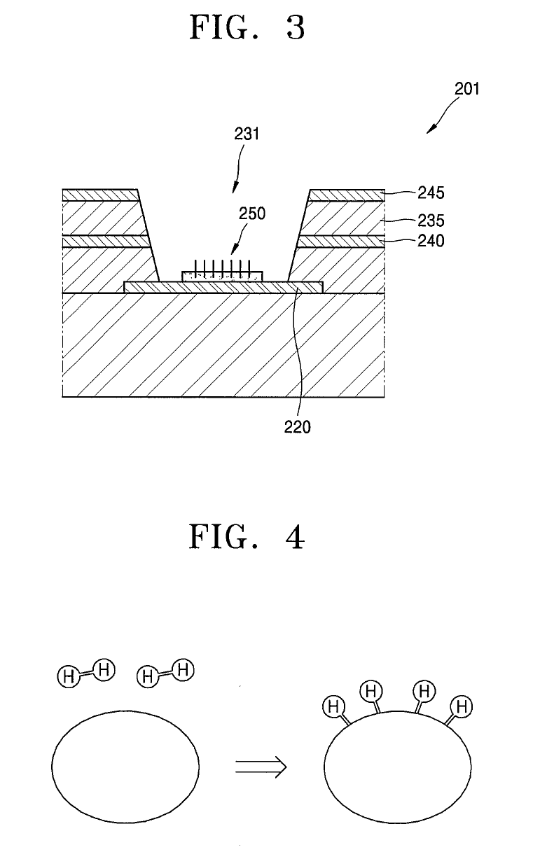

FIG. 3 is a partial cross-sectional schematic view illustrating another electron emission device 201 for the electron emission display device 100 of FIG. 1.

As compared with the electron emission device 101 illustrated in FIG. 2, the electron emission device 201 illustrated in FIG. 3 further includes a second insulating layer 235 disposed on a top surface of a gate electrode 240, and a focusing electrode 245 formed on a top surface of the second insulating layer 235.

When the electrons emitted from an electron emission source 250 by the field formed between the cathode 220 and the gate electrode 240 are accelerated toward a phosphor layer, the focusing electrode 145 focuses the electrons toward (or makes the electrons go straight toward) a phosphor layer. For example, in one embodiment, a low (−) voltage is applied to the focusing electrode 245, so that the electrons emitted from the electron emission source 250 are not scattered in side directions but go straight toward a phosphor layer.

When hydrogen atoms are attached to an electron emission material, since the electrical resistance of the electron emission material is reduced and an electron emission barrier is reduced, the electron emission display device including the electron emission device 201 can have relatively long lifespan and/or high operation stability.

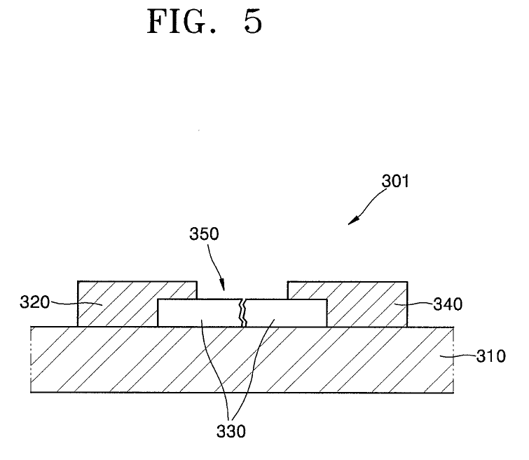

FIG. 5 is a partial cross-sectional schematic view illustrating another electron emission device 301 according to an embodiment of the present invention. In the present embodiment, the electron emission device 301 is a SCE type electron emission device. Referring to FIG. 5, the electron emission device 301 includes a base substrate 310, a plurality of first electrodes 320 formed on a side of the base substrate 310 facing a front panel, a plurality of second electrodes 340 facing the first electrodes 320, and a plurality of electron emission sources 350 disposed between the first electrodes 320 and the second electrodes 340, each of the electron emission sources 350 having a nanogap on a conductive portion 330 (e.g., a conductive thin film) between one of the first electrodes 310 and a corresponding one of the second electrodes 340. As such, when a voltage is applied to the first and second electrodes 320 and 340 to let current flow over the conductive portion 330, electrons are emitted from the nanogap due to an electron tunneling phenomenon.

A method of manufacturing an electron emission display device according to an embodiment of the present invention will now be explained in more detail below.

The electron emission display device may be manufactured as follows. First, after an electron emission device and a front panel are manufactured, a hydrogen emitter, made of a hydrogen compound containing at least one metallic element selected from the group of metallic elements including Zr, Ti, Ta, V, Mg, Th, Mn, Fe, Co, and Ni, is disposed on a front substrate, a base substrate, or other suitable position in a vacuum space as shown in FIG. 1, and a sealing process is performed with a sealing material such as frit. Next, a gas filled in the inner space is exhausted through an exhaust outlet (e.g., the exhaust outlet 160) and a tip off process is completed.

Next, the electron emission display device is heated to emit hydrogen electrons from the hydrogen emitter. The emitted hydrogen electrons are adsorbed by an electron emission material of an electron emission source, or resolve an active gas (such as oxygen or radical ions) remaining in the vacuum space of the electron emission display device.

Next, a gettering process is performed using a Ba-based getter material to remove a residual hydrogen gas other than the consumed hydrogen atoms, thereby forming (or making) the inner vacuum space.

That is, the electron emission display device may be manufactured in the order of an exhausting process, a hydrogen emission process, and a gettering process. Alternatively, for the purpose of improving the degree of vacuum, the electron emission display device may be manufactured in the order of a first exhausting process, a hydrogen emission process, a gettering process, and a second exhausting process, in the order of the first exhausting process, the hydrogen emission process, the second exhausting process, and the gettering process, or in the order of the first exhausting process, the hydrogen emission process, the second exhausting process, the gettering process, and a third exhausting process.

The hydrogen emitter may be manufactured in advance, or generated during the hydrogen charging after the metal compound is disposed.

While it is described that the hydrogen emitter is disposed in the electron emission display device and thus the hydrogen atoms are adsorbed by the electron emission material, the present embodiment is not limited thereto and can be modified as follows.

A first modified method of manufacturing the electron emission display device will now be explained in more detail below.

In order to electrically connect the cathode to the electron emission material of the electron emission device, the electron emission source is formed on a top surface of the cathode. Thereafter, the electron emission device and the front panel including the anode and the phosphor layer are sealed with a sealing material such as frit, thereby preparing the electron emission display device. Before exhausting a gas in the inner space of the electron emission display device, a hydrogen gas is filled into the inner space through an exhaust outlet (e.g., the exhaust outlet 160) to be kept at a partial pressure or vacuum of 10⁻¹⁰ to 10⁻¹ torr.

Next, a voltage is applied to the electrodes constituting the electron emission display device and the electron emission display device is driven to emit electrons from the electron emission material in a range from 0.1 μA/cm² to 200 μA/cm² for a time period ranging from 1 to 60 minutes. The hydrogen gas is excited by the electrons emitted by the electron emission material and accelerated by the anode to generate hydrogen atoms. Some of the hydrogen atoms are attached to a surface of the electron emission material to passivate defects on the surface of the electron emission material, thereby reducing the electrical resistance of the electron emission material of the electron emission device.

Next, exhausting, exhaust outlet closing, and gettering processes are performed, thereby completing the electron emission display device.

Before explaining second and third modified methods of manufacturing the electron emission display device, the activity of a metal catalyst for hydrogen dissociation will be first explained with reference to FIG. 4.

FIG. 4 is a schematic view illustrating the activity of a metal catalyst for hydrogen dissociation.

Referring to FIG. 4, when a hydrogen gas exists in a space where a metal catalyst for hydrogen dissociation, which is made of Pt, Ru, Cr, Co, Mo, Si, Sn, Pd, or combinations thereof, is present, the hydrogen gas is dissociated into atomic hydrogen on a surface of the metal catalyst. When the metal catalyst for hydrogen dissociation is disposed in the electron emission display device and heated at a temperature (that may be predetermined), the hydrogen atoms are emitted from the metal catalyst. The emitted hydrogen atoms are adsorbed by a surface of a carbon material used for the electron emission source of the electron emission device, or resolve an active gas, such as oxygen or radical ions, remaining in the electron emission display device. Accordingly, structural defects on the surface of the carbon material are removed and thus the electrical resistance of the carbon material is reduced and heat generated during the electron emission of the electron emission device is reduced as well. Also, when the active gas remaining in the electron emission display device is resolved, a factor for accelerating the degradation of the electron emission material is removed, thereby increasing the lifespan and electron emission efficiency of the electron emission material.

A second modified method of manufacturing the electron emission display device based on the aforesaid principle will now be explained in more detail below.

First, the metal catalyst for hydrogen dissociation is coated on the surface of the electron emission material, and a composition for forming the electron emission source is prepared with the coated electron emission material. The composition for forming the electron emission source is coated on an electron emission source hole 131 (FIG. 2), 213 (FIG. 3) through a general printing process, and then heat-treatment and surface-treatment processes are performed, thereby manufacturing the electron emission device. Next, the front panel and the electron emission device are sealed, and the electron emission source is exposed to a hydrogen gas for a period of time (that may be predetermined). During the exposure, the hydrogen gas is dissociated into atomic hydrogen, and the atomic hydrogen is present on the metal catalyst coated on the electron emission material, thereby improving the electron emission efficiency of the electron emission source. The metal catalyst for hydrogen dissociation may be Pt, Ru, Cr, Co, Mo, Si, Sn, Pd, or metal compounds thereof.

A third modified method of manufacturing the electron emission display device will now be explained in more detail.

First, a composition for forming the electron emission device including particles of the metal catalyst for hydrogen dissociation as fillers is prepared. Next, the front panel and the electron emission device are sealed, and the electron emission source is exposed to a hydrogen gas for a period of time (that may be predetermined). During the exposure, the hydrogen gas is dissociated into atomic hydrogen, and some of hydrogen atoms are attached to a surface of the electron emission material, thereby improving the electron emission efficiency of the electron emission source. The metal catalyst for hydrogen dissociation may be Pt, Ru, Cr, Co, Mo, Si, Sn, Pd, or metal compounds thereof. The particles of the metal catalyst for hydrogen dissociation may have a diameter ranging from 0.002 to 2.0 μm.

The exposing of the electron emission source to the hydrogen gas in the second and third modified methods may be performed at a hydrogen partial pressure ranging from 0.1 to 2.0 bar for a time period ranging from about 1 to 60 minutes. When the exposing of the electron emission source to the hydrogen gas is performed for less than 1 minute, the hydrogen atoms cannot be sufficiently attached to the electron emission material. When the exposing of the electron emission source to the hydrogen gas is performed for more than 60 minutes, the hydrogen atoms are not more effectively attached to the electron emission material.

As described above, when the hydrogen atoms are attached to the surface of the carbon nanotube used as the electron emission material, the electron emission barrier is reduced and thus the electron emission material can have improved electron emission efficiency. Also, the electron emission display device including the electron emission material can have higher operation stability and longer lifespan.

While the invention has been described in connection with certain exemplary embodiments, it is to be understood by those skilled in the art that the invention is not limited to the disclosed embodiments, but, on the contrary, is intended to cover various modifications included within the spirit and scope of the appended claims and equivalents thereof.

What is claimed is:

1. An electron emission material having a surface to which hydrogen atoms are attached.

2. An electron emission display device comprising:
a front panel having a phosphor layer;
an electron emission device adhered to the front panel with a space therebetween; and
a hydrogen emitter in the space defined by the front panel and the electron emission device.

3. The electron emission display device of claim 2, wherein the hydrogen emitter comprises a hydrogen compound comprising at least one metallic element selected from the group consisting of Zr, Ti, Ta, V, Mg, Th, Mn, Fe, Co, and Ni.

4. The electron emission display device of claim 2, wherein the front panel comprises:
a front substrate comprising a visible light transmitting material;
an anode on a side of the front substrate facing the electron emission device; and
a phosphor layer adjacent to the anode.

5. The electron emission display device of claim 4, wherein the hydrogen emitter is disposed on the front panel.

6. The electron emission display device of claim 2, wherein the electron emission device comprises:
a base substrate;
a plurality of cathodes on a side of the base substrate facing the front panel;
a plurality of insulating layers disposed on the cathodes and having a plurality of first electron emission source holes to partially expose the cathodes;
a plurality of gate electrodes on the insulating layers and having a plurality of second electron emission source holes to partially expose the cathodes; and
a plurality of electron emission sources electrically connected to the cathodes in the first and second electron emission source holes.

7. The electron emission display device of claim 2, wherein the electron emission device comprises:
a base substrate;
a plurality of cathodes on a side of the base substrate facing the front panel;
a plurality of first insulating layers on the cathodes and having a plurality of first electron emission source holes to partially expose the cathodes;
a plurality of gate electrodes on the first insulating layers and having a plurality of second electron emission source holes to partially expose the cathodes;
a plurality of second insulating layers on the gate electrodes and having a plurality of third electron emission source holes to partially expose the cathodes;
a plurality of focusing electrodes on the second insulating layers and having a plurality of fourth electron emission source holes to partially expose the cathodes; and
a plurality of electron emission sources electrically connected to the cathodes in the first, second, third, and fourth electron emission source holes.

8. The electron emission display device of claim 2, wherein the electron emission device comprises:
a base substrate;
a plurality of first electrodes formed on a side of the base substrate facing the front panel;
a plurality of second electrodes facing the first electrodes; and
a plurality of electron emission sources disposed between the first electrodes and the second electrodes, each of the electron emission sources having a nanogap on a conductive portion between one of the first electrodes and a corresponding one of the second electrodes.

9. An electron emission device comprising:
a base substrate;
a plurality of first electrodes at a side of the base substrate;
a plurality of second electrodes at the side of the base substrate; and
a plurality of electron emission sources electrically connected to the first electrodes and/or the second electrodes and comprising an electron emission material having a surface to which hydrogen atoms are attached.

10. The electron emission device of claim 9, further comprising:
a hydrogen emitter for providing the hydrogen atoms to the electron mission material.

11. The electron emission device of claim 10, wherein the hydrogen emitter comprises a hydrogen compound comprising at least one metallic element selected from the group consisting of Zr, Ti, Ta, V, Mg, Th, Mn, Fe, Co, and Ni.

12. The electron emission device of claim 9, wherein the hydrogen emitter is disposed on a front panel having a phosphor layer and facing the base substrate.

13. The electron emission device of claim 9, further comprising:
a plurality of insulating layers disposed on the first electrodes and having a plurality of first electron emission source holes to partially expose the first electrodes, wherein the plurality of second electrodes are on the insulating layers and have a plurality of second electron emission source holes to partially expose the first electrodes, and wherein the plurality of electron emission sources are electrically connected to the first electrodes in the first and second electron emission source holes.

14. The electron emission device of claim 9, further comprising:
a plurality of first insulating layers on the first electrodes and having a plurality of first electron emission source holes to partially expose the first electrodes, wherein the plurality of second electrodes are on the first insulating layers and have a plurality of second electron emission source holes to partially expose the first electrodes;
a plurality of second insulating layers on the second electrodes and having a plurality of third electron emission source holes to partially expose the first electrodes; and
a plurality of focusing electrodes on the second insulating layers and having a plurality of fourth electron emission source holes to partially expose the first electrodes, wherein the plurality of electron emission sources are electrically connected to the first electrodes in the first, second, third, and fourth electron emission source holes.

15. The electron emission device of claim 9, wherein the plurality of first electrodes and the plurality of second electrodes are on the base substrate and face each other, and wherein the plurality of electron emission sources are between the first electrodes and the second electrodes, each of the electron emission sources having a nanogap on a conductive portion between one of the first electrodes and a corresponding one of the second electrodes.
